(19) United States
(12) Patent Application Publication
(10) Pub. No.: US 2001/0055377 A1
(43) Pub. Date: Dec. 27, 2001

(54) TELEPHONE LINE ON-HOOK EVENT DETECTOR

(76) Inventors: RAPHAEL RAHAMIM, ORANGE, CA (US); FRANK SACCA, WEST COVINA, CA (US); THOMAS GREY BEUTLER, TUSTIN, CA (US)

Correspondence Address: LYON & LYON LLP, 633 WEST FIFTH STREET, SUITE 4700, LOS ANGELES, CA, 90071, US

(21) Appl. No.: 09/212,718

(22) Filed: Dec. 16, 1998

(51) Int. Cl. H04M 1/56; H04M 3/00

(52) U.S. Cl. 379/142.12; 379/399.02; 379/382

(57) ABSTRACT

A ring detect/Caller I.D. detect circuit employs first and second operational amplifiers supplied with a differential input from the AC side of a diode bridge. The differential input is converted to a single ended input supplied in a first mode to a ring detect comparator supplied with a plurality of selectable reference voltages and in a second mode to a comparator which produces a digital Caller I.D. output signal. An impedance in the feedback loop of the first and second operational amplifiers is switch-selectable to enable the first and second modes of operation, and each of the selectable reference voltages is chosen to permit proper ring signal detection in a particular corresponding geography.

### BACKGROUND OF THE INVENTION

1. Field of the Invention

The subject invention relates to the field of communications and more particularly to improved event detection circuitry for telephones. The events detected may include ring, Caller I.D. and Line Polarity Reversal.

2. Description of Related Art

Ring detection is normally associated with a frequency range and threshold level of the incoming ring signal, which may vary from country-to-country, worldwide. The threshold, in general, can be set by using appropriate zener diodes, whereas the frequency of the incoming signal can be measured by a microcontroller. The threshold, therefore, is fixed, and the zeners must be replaced depending on the country in which the circuit operates. This limitation is highly disadvantageous, as is the relatively high cost of the zener diodes and the requisite high-voltage capacitor.

Prior art interface circuitry for handling Caller I.D. transmissions has employed cumbersome electromechanical Caller I.D. relays and attendant circuitry, particularly in data modem applications. Such Caller I.D. relays are typically used to provide a low A.C. impedance audio path for the Caller I.D. signal.

Another signal on the telephone line is Line Polarity Reversal (LPR). To send an LPR signal, the central office switch reverses the polarity of the battery voltage on the telephone line. In the UK, LPR is sent to alert a terminal to prepare to receive Caller I.D. data. Conventionally, LPR is detected with an opto coupler.

### SUMMARY OF THE INVENTION

A telephone line interface circuit according to the invention includes an amplification stage having an input connected to receive a signal which is a representation of a telephone line tip and ring signal. A ring-detect comparator receives an output from the amplification stage and has a reference voltage supplied thereto, whose value may be varied depending on the country of operation.

In one embodiment, the reference voltage is supplied by a digital controller programmed to select the value of the reference voltage so as to define one of a number of ring voltage levels at the input of the comparator. In another embodiment, a set of on-chip voltage reference levels is provided.

According to other aspects of the invention, various components of the disclosed circuitry may be utilized to perform a Caller I.D. detect function and to detect LPR. A microcontroller or other on-chip processor can be used to switch to a Caller I.D. mode after ring-detect or other events. In one embodiment, such operation permits use of much of the same circuitry to perform ring detect, LPR detect and Caller I.D. detect functions, while avoiding the use of relays and opto couplers.

### BRIEF DESCRIPTION OF THE DRAWINGS

The exact nature of this invention, as well as its objects and advantages, will become readily apparent upon reference to the following detailed description when considered in conjunction with the accompanying drawings, in which like reference numerals designate like parts throughout the figures thereof, and wherein:

FIG. 1 is a circuit diagram illustrating prior art ring detect circuitry;

FIG. 2 is a circuit diagram illustrating a simplified ring detect circuit;

FIG. 3 is a circuit diagram illustrating off-chip circuitry of the preferred embodiment of the invention;

FIG. 4 is a circuit diagram illustrating on-chip circuitry of the preferred embodiment;

FIG. 5 is a circuit diagram of an alternative embodiment; and

FIG. 6 is a circuit diagram of a second alternative embodiment.

### DETAILED DESCRIPTION OF THE PREFERRED EMBODIMENTS

The following description is provided to enable any person skilled in the art to make and use the invention and sets forth the best modes contemplated by the inventors for carrying out their invention. Various modifications, however, will remain readily apparent to those skilled in the art.

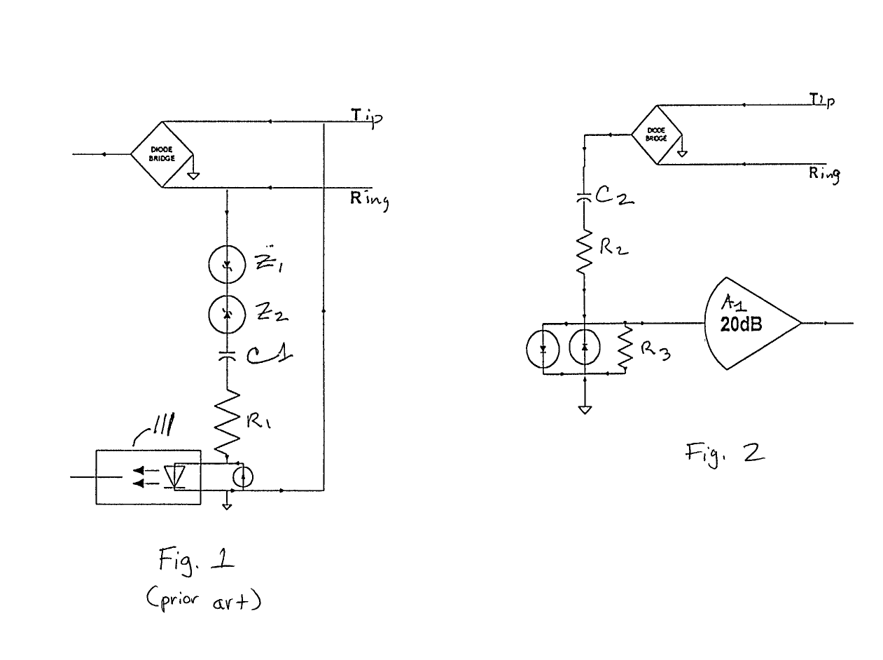

Conventional ring-detect circuits are bulky and relatively expensive due to the high voltage of the ring signal and the isolation required between the system and the telephone line. A typical circuit is shown in FIG. 1. The circuit of FIG. 1 includes an opto-isolator device 111, a high-voltage capacitor C1, and two zener diodes Z1, Z2 that set the desired voltage threshold of the incoming ring signal. A large capacitor C1 is required to provide enough energy across the opto-isolator 111 to saturate a transistor (not shown), which in turn generates a square wave representation of the ring signal.

If the isolation barrier between the system and the telephone line is implemented by means other than an opto-isolator it is possible to use a smaller coupling capacitor C2, without zeners Z1, Z2, in the circuit configuration shown in FIG. 2. In this configuration, the threshold is somewhat arbitrary, as it is defined only by the voltage divider ratio R3/R2+R3 and the gain of the amplifier A1. To obtain more discrimination of the incoming signal, it may still be necessary to add zeners in series with the resistor R2

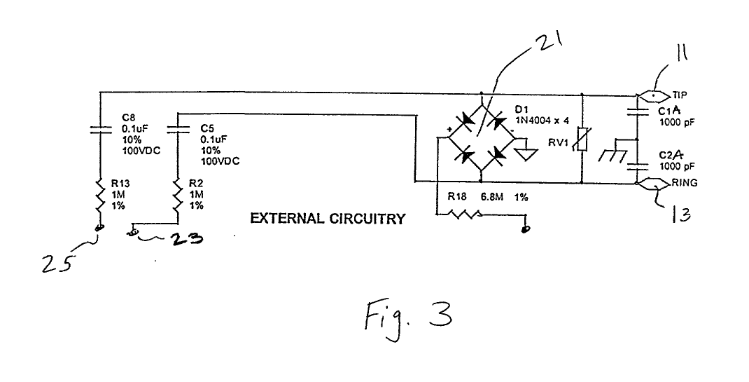

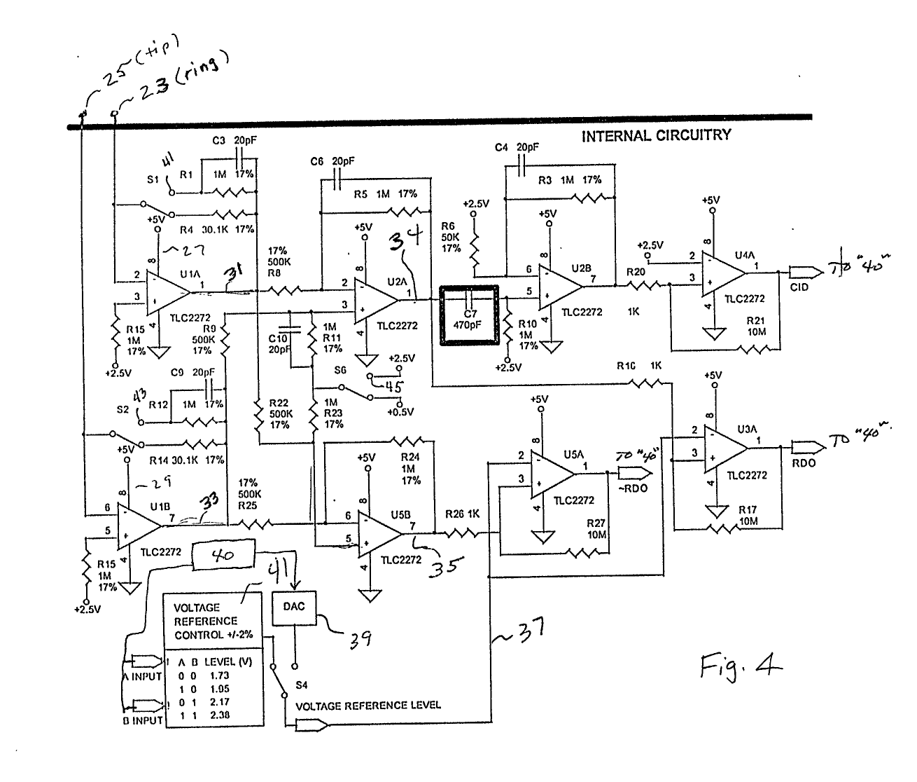

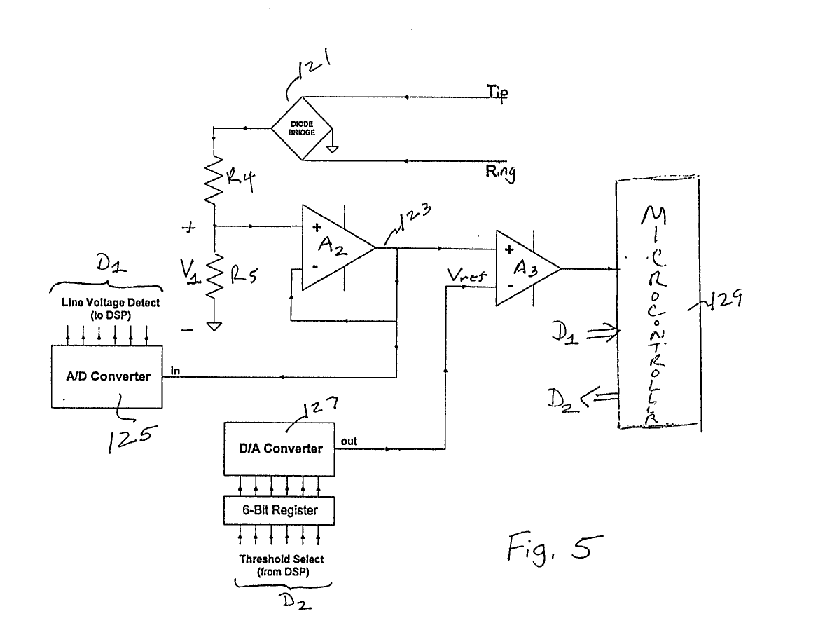

The circuits of FIGS. 1 and 2 have a considerable number of disadvantages, which are overcome by the approach illustrated in connection with the preferred embodiment of the invention illustrated in FIGS. 3 and 4. The preferred embodiment of FIGS. 3 and 4 is particularly suited for implementation in a data modem wherein a digital processor or controller sequences and otherwise controls various system operations.

FIG. 3 illustrates external or “off-chip” circuitry employed according to the preferred embodiment. According to the approach of preferred embodiment, ring detect is performed off the A.C. side of a diode bridge 21. As may be seen in FIG. 1, the tip and ring signals on respective terminals 11, 13 are applied to opposite sides of the diode bridge 21. First and second capacitors C1A, C2A are connected respectively to the tip and ring and have a common interconnection grounded. A metal oxide varistor RV1 is connected between the tip and ring terminals for the purpose of supressing high voltage surges.

The respective tip and ring signals on the terminals 11, 13 are capacitively coupled by capacitors C8 and C5 through resistors R13, R2 to the signal points 25, 23. The capacitive coupling renders the ring-detect independent of the DC voltage on the telephone line, while the resistors R13, R2 are made large, e.g., 1 megohm, in order that the following circuitry does not affect modem operation by placing any extra load on the telephone line interface. The voltage and current at the device pins 23, 25 must be within the limits of the electrostatic discharge diodes conventionally used to prevent electrostatic discharge damage to the device (chip).

FIG. 4 illustrates ring detect circuitry which is “internal,” i.e., which is formed “on-chip;” preferably as a part of a VLSI large scale integrated circuit. The circuitry of FIG. 4 features a differential input of the signals at points 23, 25 to respective operational amplifiers U1A, U1B. The noninverting inputs of the respective amplifiers U1A, U1B are connected through respective resistors R15 to a reference voltage source, for example, +2.5 volts. Respective resistors R4, R14 are connected in respective feedback paths to the inverting inputs of the amplifiers U1A, U1B via respective switches S1,S2. Respective power supply voltages of e.g. +5 volts are supplied to the respective amplifiers U1A, U1B via leads 27, 29.

The outputs 31, 33 of the respective operational amplifiers U1A, U1B are coupled through respective resistors R8, R9 to the inverting and noninverting inputs, respectively, of an operational amplifier U2A. The noninverting input of the amplifier U2A is further connected through a resistor R11 to a voltage reference, namely, +0.5 volts in the example under discussion. The converter amplifier U2A has a resistor R5 and a capacitor C6 connected in parallel therewith in a feedback path from its output to its inverting input.

The amplifier U2A converts the differential input from amplifiers U1A, U1B into a single-ended output on line 34. The output signal on line 34 is supplied as a first input to the noninverting input of a ring detect comparator U3A. The second input to the ring detect comparator U3A is a voltage reference signal supplied via line signal line 37 to its inverting input. The output of the comparator U3A is the ring detect signal RDO.

The voltage reference signal may be supplied either from a digital-to-analog converter 39 via a digital control processor 40 or from one of four on-chip voltage levels digitally selected by such a processor. As illustrated in Table 41, these four voltage levels may be 1.73 volts, 1.95 volts, 2.17 volts and 2.38 volts. Selection among four such voltages should accommodate most of the countries around the world. If more precision in the reference voltage is required, a wider variety of reference voltages may be applied by switching in the digital-to-analog converter 39 via a switch S4.

The respective outputs 31, 33 of the respective operational amplifiers U1A, U1B are also supplied via respective resistors R22, R25 to the noninverting and inverting inputs, respectively, of a third operational amplifier U5B. The converter amplifier U5B contains a resistor R24 in a feedback path from its output to its inverting input. The operational amplifier U5B serves to convert the differential input to the amplifiers U1A, U1B into a single ended output on the signal path 35. Additionally, a +0.05 volt reference voltage is connected via a switch S6 through a resistor R23 to the noninverting input of the amplifier U5B.

The output signal on line 35 is supplied to a first input of a ring detect comparator U5A. The second input to the ring detect comparator U5A is the voltage reference signal supplied on line 37.

The amplifier U5A provides an output signal −RDO. In the circuit shown, RDO will only provide an output pulse when the telephone line polarity switches from −ring/+tip to +ring/−tip. The output −RDO is needed to provide an output pulse for the other case, when the telephone line polarity switches from +ring/−tip to −ring/+tip. This is intended to provide detection of either possible case of a line polarity reversal signal.

In the example under discussion, the values of the feedback resistors R4, R14 in the feedback paths of the operational amplifiers U1A, U1B are each selected to be 30.1K ohms. This selection results in respective attenuations of 1/33 for the amplifiers U1A, U1B. Additionally, the outputs of the amplifiers U1A, U1B are supplied to the respective inputs of the converting amplifiers U2A, U5B via 500K Ω resistors R22, R25, R9, R8.

The resistors R8, R9, R22 and R25 work with the resistors R5, R11, R23 and R24, to provide a gain of 2 at U2A-1 and U5B-7. This gain combined with the +0.5 volt bias from S6 and the 1/33 attenuation from U1A and U1B, results in a full scale (0-+5 volt) halfwave rectified signal at U2A-1 and U5B-7, for a 50 volt RMS telephone line ringing signal at tip and ring. This is intended to provide optimum resolution for determining the amplitude of telephone line ringing signals between 14 and 50 volts RMS at tip and ring.

Once the cooperating digital control processor 40 senses ring detect, it activates a number of switches S1, S2, S6 to switch the circuit of FIG. 4 to the Caller I.D. mode. This switching to Caller I.D. mode is achieved by changing the positions of switches S1, S2, S6 such that signal points 41, 43 are connected into the feedback path of the respective input operational amplifiers U1A, U1B and the voltage reference conducted through switch S6 is supplied by signal point 45. In this manner, a resistor R1 and a capacitor C3 connected in parallel therewith are inserted into the feedback path of the amplifier U1A, while a resistor R12 and a capacitor C9 connected in parallel therewith are inserted into the feedback path of the amplifier U1B. The reference voltage supply to the noninverting input of the operational amplifier U2A is additionally switched to a 2.5 volt reference supplied through a resistor R11 which has a capacitor C10 connected in parallel therewith.

The Caller I.D. signal appears at the output 34 of the operational amplifier U2A and is supplied through a blocking capacitor C7 to the noninverting input of an amplifier U2B. The noninverting input of amplifier U2B is further connected through a resistor R10 to a 2.5 volt reference source. Feedback from the output of the amplifier U2B is supplied to its inverting input by a resistor R3 and a capacitor C4 connected in parallel therewith. The noninverting input of the amplifier U2B is further connected to a 2.5 volt reference source through a resistor R6. The blocking capacitor C7 is an off-chip part since its value, e.g. 470 pF, is too large for VLSI.

The amplifier U2B constitutes an amplification stage which supplies an analog output signal via resistor R20 to the noninverting input of a comparator U4A. A resistor R21 is connected between the output of the amplifier U4A and its noninverting input, while the inverting input of the amplifier U4A is connected to a 2.5 volt reference source. A 5 volt power supply voltage is also supplied to the comparator amplifier U4A.

As known in the art, Caller I.D. input signals typically comprise a frequency shift keyed (FSK) signal wherein a frequency of 1200 hertz represents a logic 1 and a frequency of 2200 hertz represents a logic 0. The Caller I.D. input signal is typically at minus-ten to minus-forty dBm (about 10 to 300 millivolts RMS). Accordingly, for operation in the Caller I.D. mode, high valued resistors R1, R12, e.g., 1 megohm, are switched into the feedback path in order to provide unity gain from the amplifiers U1A, U1B. The capacitors C3, C9 provide a low pass filtering effect to roll off any high frequency noise. The differential input provided by the amplifiers U1A, U1B is again converted to a single ended output 34 by the operational amplifier U2A. The 2.5 volt reference switched in via terminal 45 to the noninverting input of the amplifier U2A provides a symmetrical audio output signal. The amplifier U2B provides a gain of, for example 20:1.

The comparator U4A functions to convert the analog audio FSK signal into a digital Caller I.D. output signal for analysis by subsequent circuitry. Such subsequent circuitry may constitute a state machine set up to read the Caller I.D. signal or other digital processing circuitry. The analog signals from U2A-1 or U2B-7 could be used as inputs to a CODEC.

Representative component values for the components in the circuit example under discussion and not already provided above are given in the following table:

| | | |
|---|---|---|
| C6: 20 pF | R11: 1 MΩ | R6: 50 kΩ |
| C10: 20 pF | R5: 1 MΩ | R16: 1 kΩ |
| C4: 20 pF | R24: 1 MΩ | R10: 1 MΩ |
| C3: 20 pF | R3: 1 MΩ | |
| C9: 20 pF | R27: 10 MΩ | |
| C5: .1 μF | R21: 10 MΩ | |
| C8: .1 μF | R17: 10 MΩ | |

These component values are provided as an example only and may vary in various embodiments constructed according to the invention.

An alternative ring detect circuit embodiment is shown in FIG. 5. In the circuit of FIG. 5, a voltage divider formed by first and second resistors R4, R5 is connected to the D.C. output of a diode bridge 121 in a telephone line interface circuit. The voltage divider generates a low voltage V1 across the resistor R5 which is a representation of the line voltage. The low voltage is buffered by an op-amp A2 to decrease its source impedance. The output 123 of the op-amp A2 is supplied to the input of an A/D converter 125 and to the first reference input of a comparator A3. The second reference input of the comparator A3 is coupled to the output of a D/A converter 127.

The output of the comparator A3 is coupled to a microcontroller 129, which interprets the data received from the comparator A3. The controller 129 determines the line voltage by reading the output D1 of the A/D converter 125 and sets the reference of the comparator A3 by writing to the input D2 of the D/A controller. Since the output of the op-amp A2 is a representation of the line voltage, the comparator A3 is triggered when an event on the line exceeds the reference VREF set by the microcontroller 129 via D2. The microcontroller 129 sets this reference VREF according to a predetermined stored table of digital values, depending on the country of operation, thereby providing a programmable ring voltage threshold. Furthermore, the microcontroller 129 can determine the amplitude and frequency of the ring signal by moving the reference VREF to different voltage levels and using a simple algorithm to process the output of the comparator A3 at each corresponding reference.

The invention just disclosed provides a number of advantages. First, it saves the cost of zener diodes, an optocoupler, reverse protection diodes, and possibly a high voltage coupling capacitor. It is adaptive to changes in DC line voltage because the reference VREF is variable and is also adaptive to worldwide DC and ring requirements. The circuit further can be used to detect line polarity reversal and can generate a pulse when an event occurs on the line voltage, which can be used as an interrupt to the microcontroller or other digital processor. The circuit can further detect whether an extension phone is off-hook and whether a DAA (data access arrangement) is disconnected from the line. The circuit may share the ADC and DAC with the off-hook circuit and is ideal for integration into an ASIC.

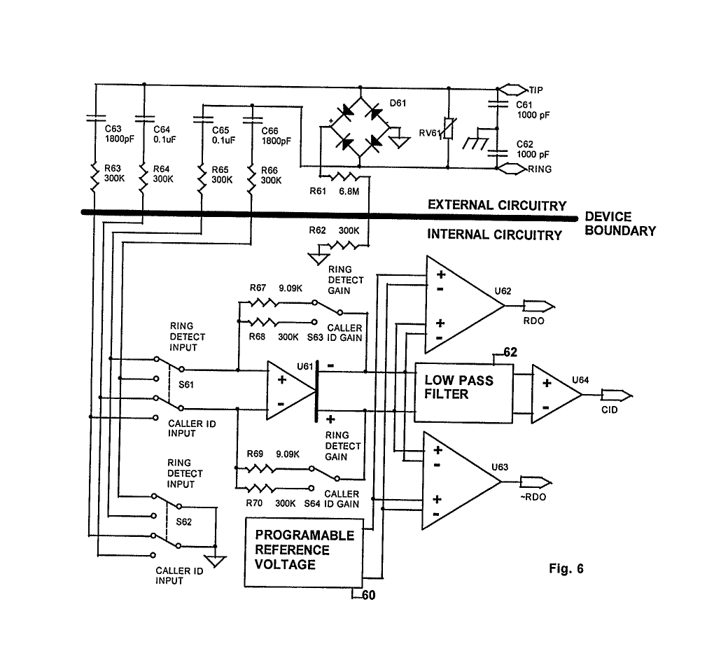

Another alternative embodiment of the present invention is illustrated schematically in FIG. 6. This design is more efficient for certain VLSI implementations (i.e. uses less die area) than the circuit of FIG. 4. The ring detect circuit of FIG. 6 uses a fully differential amplifier U61 having a gain of —30 dB followed by two comparators U62, U63 having a positive and a negative threshold voltage. Note that unlike the circuit of FIG. 4, this embodiment does not have a differential to single ended conversion before the comparators. Also, this design has less programming complexity than the circuit of FIG. 5. The comparators U62, U63 have programmable threshold voltages and are connected to a programmable reference 60, which may be implemented as shown in FIG. 4 using a DAC or a voltage reference. The programmable reference voltage 60 provides a voltage level to compare to the incoming ring detect signal. This is necessary since different countries have different valid ring detect levels.

The amplifier U61 is coupled to the Tip and Ring signals through two separate RC networks. The first network, consisting of 0.1 uF capacitors C64, C65 and 300K resistors R64, R65, is connected to the amplifier U61 via switch S61. In order to obtain a good indication of the absolute amplitude of a ring signal, the frequency response of the time constants must be relatively flat down to the frequencies for ring detection. In this case, a flat frequency response from approximately 15-70 Hz makes it easier to detect an absolute amplitude of the ring detect signal. Once a ring signal has been detected, the switch S61 switches to connect the amplifier U61 to the Caller I.D. RC network.

For Caller I.D. detection, a high-pass filter may be necessary to reduce low frequency interference. A Caller I.D. signal is between 1200-2200 Hz, and therefore harmonics of 60 Hz power line interference may interfere with the Caller I.D. detection. The second RC network, comprising 1800 pF capacitors C63, C66, and 300K resistors R63, R66, provides attenuation for signals under 300 Hz, thereby reducing interference. For many applications, the additional expense of adding the high-pass filter network may not be desirable, and if the performance is satisfactory, may be eliminated. When one RC network is selected, the other is grounded via S62, to ensure that the ESD diodes are not improperly biased, thereby minimizing any distortion problems.

Switches S63 and S64 set the gain control across the amplifier U61 for both ring detect and caller id. The gain attenuation is approximately 17 to 1 between the ring detect gain the Caller I.D. gain, with the caller id having unity gain. The comparators U62 and U63 provide the Ring Detect and Line Polarity Reversal signals, with RDO and ˜RDO being complementary digital signals. The comparator U64 provides the Caller I.D. digital output signal CID. The low pass filter 62 is optional, and is only implemented if needed to provide satisfactory Caller I.D. performance.

Those skilled in the art will thus appreciate that various adaptations and modifications of the just-described preferred embodiment can be configured without departing from the scope and spirit of the invention. For example, circuitry can be straightforwardly constructed from the teachings herein which omits either the Caller I.D. detect or Line Polarity Reversal detection features, or both. Various parameters of operation such as attenuation factors, bias levels and component types may further be changed to adapt to various applications. Therefore, it is to be understood that, within the scope of the appended claims, the invention may be practiced other than as specifically described herein.

What is claimed is:

1. A telephone line interface circuit comprising:
a differential amplifier gain stage receiving respective inputs from a tip and a ring, the gain stage providing an output; and
a comparator circuit connected to receive the output.

2. The circuit of claim 1, wherein the comparator circuit comprises a ring detect comparator amplifier supplied with one of a plurality of selectable reference voltages.

3. The circuit of claim 1, wherein the differential amplifier gain stage comprises:
first and second operational amplifiers each supplied with a differential input; and
first and second amplifiers having respective inputs connected to respective outputs of the first and second operational amplifiers, each the first and second amplifiers providing a single ended output.

4. The circuit of claim 1, wherein the comparator circuit comprises a comparator which produces a digital Caller I.D. output signal.

5. The circuit of claim 3 further comprising an impedance in the feedback loop of the first and second operational amplifiers, each the impedance being switch-selectable between first and second values to enable respective first and second modes of operation.

6. The circuit of claim 1, wherein the differential amplifier gain stage comprises a switch selectable impedance activatable to switch between ring detect and Caller I.D. detect modes of operation.

7. The circuit of claim 2, wherein each of the selectable reference voltages is chosen to permit proper ring signal detection in a particular corresponding geography.

8. The circuit of claim 1, wherein the gain stage is supplied with a tip signal through a first resistor and a ring signal through a second resistor, the values of the first and second resistors being chosen such that the circuit presents a negligible load to a telephone line supplying the tip and ring signals.

9. The circuit of claim 8 further including first and second D.C. blocking capacitors connected respectively to the first and second resistors.

10. The circuit of claim 1, wherein the differential amplifier gain stage comprises:
a single amplifier having differential inputs and differential outputs.

11. The circuit of claim 10, wherein the comparator circuit comprises a ring detect comparator amplifier supplied with one of a plurality of selectable reference voltages.

12. The circuit of claim 10, wherein the comparator circuit comprises a comparator which produces a digital Caller I.D. output signal.

13. The circuit of claim 11, wherein each of the selectable reference voltages is chosen to permit proper ring signal detection in a particular corresponding geography.

14. The circuit of claim 10, wherein the comparator circuit comprises:
a ring detect comparator amplifier supplied with one of a plurality of selectable reference voltages; and
a comparator which produces a digital Caller I.D. output signal.

15. The circuit of claim 14, wherein the circuit further comprises a switch selectable RC network connected to the input of the amplifier.

16. The circuit of claim 15, wherein the RC network comprises:
a first RC network connected to the amplifier during a ring signal detection; and
a second RC network connected to the amplifier during a Caller I.D. signal detection.

17. The circuit of claim 16, wherein the first RC network has a flat frequency response from approximately 15-70 Hz.

18. The circuit of claim 16, wherein the second RC network is a high-pass filter which provides attenuation for signals under 300 Hz.

19. The circuit of claim 16, wherein the amplifier has a selectable gain for selecting between a ring detect gain and a Caller I.D. gain.

20. A method of programmable ring detection comprising the steps of:
arranging a circuit to receive a telephone line input signal and to supply an output voltage proportional to the voltage of the input signal;
comparing the output voltage to a reference voltage level to produce a ring detect signal; and
selecting the value of the reference voltage level to be one of a plurality of voltage levels, each of the plurality of voltage levels corresponding to a value selected to enable detection of a ring signal in a particular country.

21. The method of claim 20 further including the step of employing the circuit to receive a Caller I.D. signal.

22. The method of claim 21 wherein the step of employing includes the step of using a microcontroller to change the value of an impedance in the circuit.

23. The method of claim 20 wherein the step of selecting comprises the step of supplying a D/A converter with a digital representation of a selected one of the plurality of voltage levels.

24. The method of claim 23 further including the step of supplying an analog output signal of the D/A converter as the reference voltage level.

25. The method of claim 23 further including the step of employing a digital controller to supply the digital representation to the D/A converter.

26. The method of claim 25 further including the step of programming the digital controller to select the value of the digital representation so as to cause the D/A converter to produce the voltage level corresponding to the country wherein the circuit is operating.

27. The method of claim 20 wherein the circuit includes:
first and second operational amplifiers each receiving a respective input from a tip signal and a ring signal and providing respective outputs which comprise a differential output voltage; and
a third operational amplifier for converting the differential output voltage to a single ended output voltage.

28. The method of claim 27 wherein the single ended output voltage from the third operational amplifier is used in the step of comparing.

29. The method of claim 27 further comprising the step of generating a digital Caller I.D. output signal from the differential output voltage.

30. The method of claim 29 wherein the step of generating a digital Caller I.D. signal comprises the step of changing an impedance in a feedback path of each of the first and second operational amplifiers.

31. The method of claim 30 wherein the step of generating a digital Caller I.D. signal further comprises the step of changing a reference voltage value supplied to the third operational amplifier.

32. The method of claim 20 wherein the circuit includes:
a first operational amplifier having differential inputs and differential outputs, the first operational amplifier receiving a differential input of a tip signal and a ring signal and providing an output voltage.

33. The method of claim 32 wherein the output voltage comprises the signal voltage used in the step of comparing.

34. The method of claim 32 further comprising the step of generating a digital Caller I.D. output signal from the output voltage.

35. The method of claim 33, further comprising the step of selecting an RC network input to the first operational amplifier.

36. The method of claim 35, wherein the step of selecting an input RC network comprises selecting a first RC network for ring detection and a second RC network for Caller I.D. detection.

37. The method of claim 36, further comprising the step of selecting a gain for the first operational amplifier.

38. A telephone line interface circuit comprising:
an operational amplifier having an output and an input connected to receive a signal which is a representation of a line signal;
a comparator having a first input connected to receive the output of the operational amplifier, the comparator further having a second input; and
a reference voltage supply circuit connected to supply one of a plurality of reference voltage levels to the comparator, each the reference voltage level being selected to provide detection of a ring signal in a particular country.

39. The interface circuit of claim 38 wherein the reference voltage supply circuit comprises:
a D/A converter having an input for receiving a digital signal and an output supplying an analog signal as a reference voltage to the second input of the comparator; and
a digital controller connected to the input and providing the digital signal to the D/A converter.

40. The interface circuit of claim 39 wherein the digital controller is programmed to select the value of the digital signal so as to define one of a number of ring voltage levels at the input of the comparator.

41. The interface circuit of claim 39 wherein the digital controller is programmed to determine the amplitude and frequency of the ring signal.

42. The interface circuit of claim 39 wherein the signal which is a representation of a line signal is supplied by a voltage divider circuit.

43. A telephone interface circuit comprising:
at least one amplifier for receiving a respective input from a tip signal and a ring signal and providing at least one output, the output comprising a differential output voltage; and
at least one comparator connected to receive the differential output voltage for providing a digital Caller I.D. output signal or a ring detect signal.
